(19) United States
(12) Patent Application Publication
(10) Pub. No.: US 2026/0225013 A1
(43) Pub. Date: Aug. 6, 2026

(54) FILTER

(71) Applicant: SEIKO EPSON CORPORATION, Tokyo (JP)

(72) Inventors: Toshiki HARA, SUWA-SHI (JP); Masayuki OMOTO, CHINO-SHI (JP); Yasuto KAKEMURA, KAI-SHI (JP); Natsuko MIZUSAKI, SHIOJIRI-SHI (JP)

(73) Assignee: SEIKO EPSON CORPORATION, Tokyo (JP)

(21) Appl. No.: 19/458,961

(22) Filed: Jan. 26, 2026

(30) Foreign Application Priority Data
Jan. 27, 2025 (JP) 2025-011173

(51) Int. Cl. B01D 39/20; A47J 31/06; B01J 20/20

(52) U.S. Cl. CPC B01D 39/2065; A47J 31/06; B01J 20/20; B01D 2239/10; B01D 2239/1216; B01D 2239/1225; B01D 2239/1291

(57) ABSTRACT

A filter that contains carbonized cellulose fibers obtained by carbonizing cellulose fibers and capture a specific substance is provided. The carbonized cellulose fibers have a large number of pores opening to the surface, and the number of the pores having a pore diameter of 4.0 nm or more and 60 nm or less is larger than the number of the pores having a pore diameter of 0.8 nm or more and 1.2 nm or less. In the frequency distribution of the pore diameters, when the frequency of the pores having a pore diameter of 4.0 nm or more and 60 nm or less is A and the frequency of the pores having a pore diameter of 0.8 nm or more and 1.2 nm or less is B, A/B is preferably 1.5 or more and 100 or less.

The present application is based on, and claims priority from JP Application Serial Number 2025-011173, filed January 27, 2025, the disclosure of which is hereby incorporated by reference herein in its entirety.

### BACKGROUND

### 1. Technical Field

The present disclosure relates to a filter.

### 2. Related Art

Filters for removing substances suspended or dissolved in various fluids by filtration or adsorption are known. For example, a filter described in JP-A-2010-215872 includes a cellulose porous body. When the cellulose porous body takes in the substance, the substance can be removed from the fluid.

JP-A-2010-215872 is an example of the related art.

However, in the filter described in JP-A-2010-215872, for example, a specific substance such as caffeine contained in coffee cannot be selectively removed.

### SUMMARY

A filter according to an application example of the present disclosure is a filter that contains carbonized cellulose fibers obtained by carbonizing cellulose fibers and is configured to capture a specific substance, wherein the carbonized cellulose fibers have a large number of pores opening to the surface, and the number of the pores having a pore diameter of 4.0 nm or more and 60 nm or less is larger than the number of the pores having a pore diameter of 0.8 nm or more and 1.2 nm or less.

### BRIEF DESCRIPTION OF THE DRAWINGS

FIG. 1 is a diagram schematically illustrating a carbon fiber structure manufacturing apparatus for manufacturing a filter (carbon fiber structure) according to an embodiment of the present disclosure.

FIG. 2 is a partial cross-sectional view illustrating the configuration of a density adjustment unit and a carbonization unit provided in the carbon fiber structure manufacturing apparatus illustrated in FIG. 1.

FIG. 3 is a block diagram of the carbon fiber structure manufacturing apparatus illustrated in FIG. 1.

FIG. 4 is a graph illustrating a frequency distribution of pore diameters of carbonized cellulose fibers, comparing activated carbon of the related art with the filter of the present disclosure.

### DESCRIPTION OF EMBODIMENTS

### Embodiment

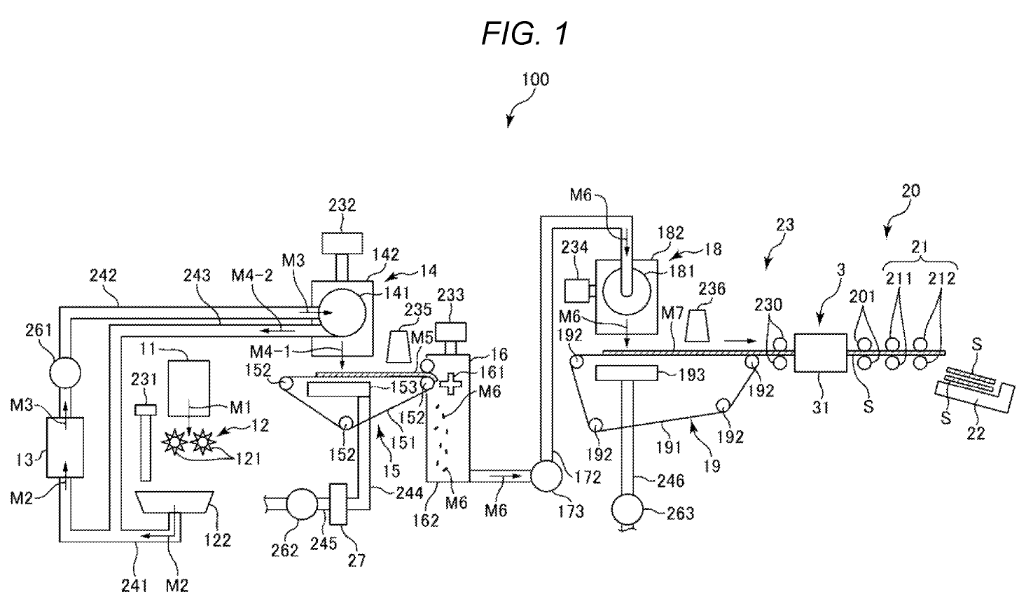

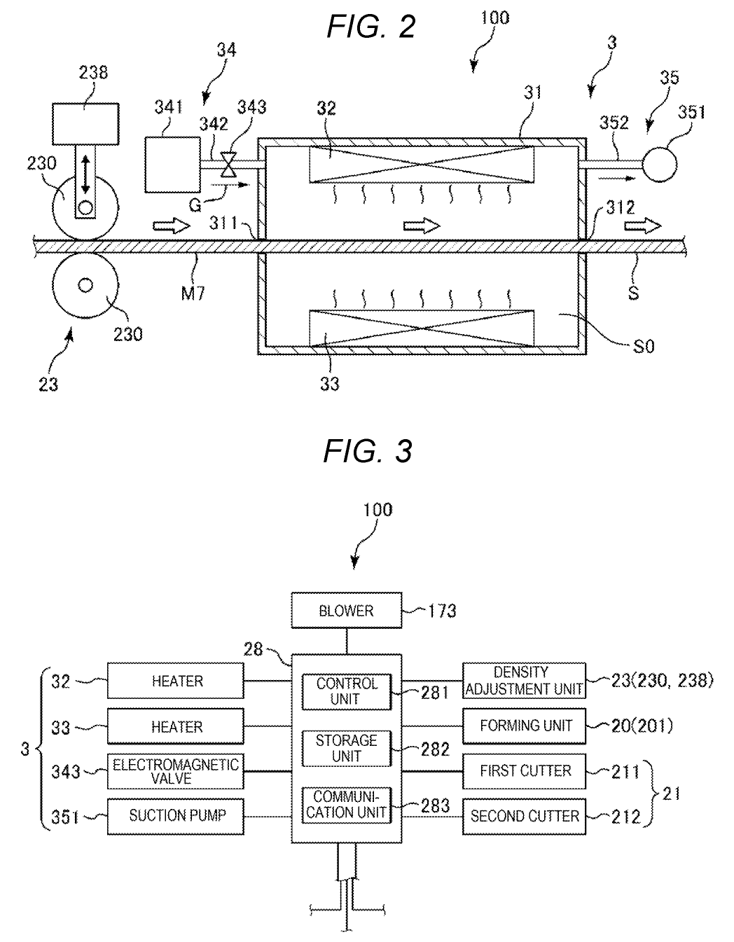

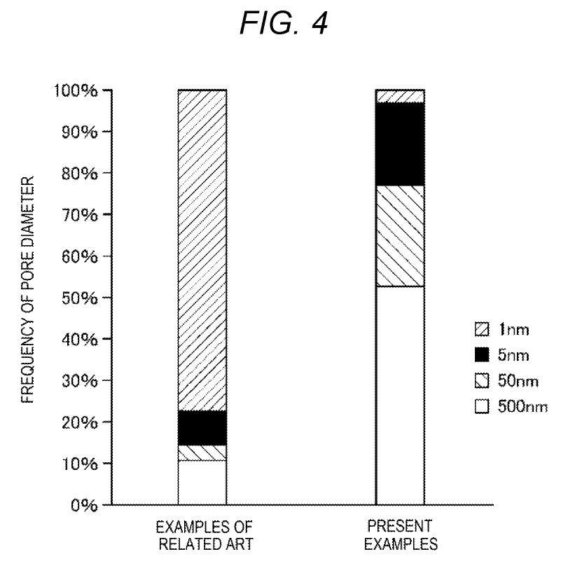

FIG. 1 is a diagram schematically illustrating a carbon fiber structure manufacturing apparatus for manufacturing a filter (carbon fiber structure) according to an embodiment of the present disclosure. FIG. 2 is a partial cross-sectional view illustrating the configuration of a density adjustment unit and a carbonization unit provided in the carbon fiber structure manufacturing apparatus illustrated in FIG. 1. FIG. 3 is a block diagram of the carbon fiber structure manufacturing apparatus illustrated in FIG. 1.

Note that, in the following description, the upper side in FIGS. 1 and 2 may be referred to as "up" or "above", and the lower side in FIGS. 1 and 2 may be referred to as "down" or "below". FIG. 1 is a schematic configuration diagram, and the positional relationship, orientation, size, and the like of each part of a carbon fiber structure manufacturing apparatus 100 are not limited to those illustrated. In addition, in FIG. 1, a direction in which a roughly ground piece M2, a defibrated material M3, a first sorted material M4-1, a second sorted material M4-2, a first web M5, a subdivided body M6, a second web M7, and a carbon fiber structure S are transported, that is, a direction indicated by an arrow, is also referred to as a transport direction. In addition, a tip side of the arrow in FIG. 1 is also referred to as a "downstream" in the transport direction, and a base end side of the arrow in FIG. 1 is also referred to as an "upstream" in the transport direction. Carbon Fiber Structure Manufacturing Apparatus

The carbon fiber structure manufacturing apparatus 100 illustrated in FIG. 1 is an apparatus for producing the carbon fiber structure S (filter) from a raw material M1 which is used paper such as used copy paper. In the present embodiment, the carbon fiber structure S is described as having a sheet shape. However, the carbon fiber structure S is not limited to this configuration, and may have a shape other than the sheet shape, for example, a three-dimensional structure such as a rod shape, a spherical shape, or a block shape.

Examples of applications of the carbon fiber structure S include a filter that adsorbs and captures a specific substance. The carbon fiber structure S may be used for other purposes, for example, as a thermally conductive material, a reinforcing material, or a conductive material.

Hereinafter, each part of the carbon fiber structure manufacturing apparatus 100 will be described with reference to FIGS. 1 to 3.

As illustrated in FIG. 1, the carbon fiber structure manufacturing apparatus 100 includes a raw material supply unit 11, a crushing unit 12, a defibrating unit 13, a sorting unit 14, a web forming unit 15, a subdividing unit 16, a dispersing unit 18, a depositing unit 19, a density adjustment unit 23, a carbonization unit 3, a forming unit 20, a cutting unit 21, a stock unit 22, and a collection unit 27.

The raw material supply unit 11 is a part that performs the raw material supply step of supplying the raw material M1 to the crushing unit 12. The raw material M1 is a sheet shape material made of a fiber-containing material containing cellulose fibers. The cellulose fiber may be a fibrous material containing cellulose as a main component as a compound, and may contain hemicellulose or lignin in addition to cellulose. The raw material M1 may be in any form such as woven fabric or nonwoven fabric. In addition, the raw material M1 may be, for example, recycled paper which is recycled and manufactured by defibrating used paper or YUPO paper (registered trademark) which is synthetic paper, or may not be recycled paper or YUPO paper (registered trademark) which is synthetic paper.

The crushing unit 12 is a part that performs the crushing step of crushing the raw material M1 supplied from the raw material supply unit 11 in air such as the atmosphere. The crushing unit 12 includes a pair of crushing blades 121 and a chute 122.

The pair of crushing blades 121 can rotate in opposite directions relative to each other to crush the raw material M1 therebetween, that is, cut the raw material M1 into the roughly ground pieces M2. The shape and size of the roughly ground pieces M2 are preferably suitable for the defibrating process in the defibrating unit 13. Examples of the shape of the roughly ground pieces M2 include a small piece having a square planar shape and a small piece having a rectangular shape, particularly a strip-shaped shape. In addition, the size of the roughly ground pieces M2 is, for example, preferably a small piece having an average length of one side of 100 mm or less, and more preferably a small piece having an average length of one side of 3 mm or more and 70 mm or less. The shape of the small piece may be other than a square or a rectangle. The thickness thereof is preferably 0.07 mm or more and 0.10 mm or less.

The chute 122 is disposed below the pair of crushing blades 121, and has a funnel shape, for example. As a result, the chute 122 can receive the roughly ground pieces M2 that have been crushed and fallen from the crushing blades 121.

In addition, above the chute 122, a humidifying unit 231 is disposed adjacent to the pair of crushing blades 121. The humidifying unit 231 is configured to humidify the roughly ground pieces M2 in the chute 122. By supplying the humidified air to the roughly ground pieces M2, it is possible to suppress the roughly ground pieces M2 from adhering to the chute 122 and the like due to electrostatic force.

The chute 122 is coupled upstream of the defibrating unit 13 via a conduit 241. That is, the downstream end of the conduit 241 is coupled to an inlet (not illustrated) of the defibrating unit 13. The roughly ground pieces M2 collected in the chute 122 pass through the conduit 241 and are transported to the defibrating unit 13.

As illustrated in FIG. 1, the defibrating unit 13 is a part that performs the defibrating step of defibrating the roughly ground pieces M2 in air, that is, in a dry manner. By the defibrating process in the defibrating unit 13, the defibrated material M3 can be produced from the roughly ground pieces M2. Here, "defibrating" means loosening the roughly ground pieces M2, in which a plurality of fibers are bonded, into fiber pieces one by one. The resulting loosened material is formed into the defibrated material M3. The shape of the defibrated material M3 is a linear shape or a band shape. In addition, the defibrated materials M3 may be present in a state of being entangled with each other to form a mass, that is, in a state of forming a so-called "lump".

In addition, the defibrating unit 13 can generate, by rotation of a rotor (not illustrated), a flow of air from the crushing unit 12 toward the sorting unit 14, that is, an air flow. As a result, the roughly ground pieces M2 can be introduced from the conduit 241 upstream of the defibrating unit 13, and after the defibrating process, the defibrated material M3 can be delivered via a conduit 242 to the sorting unit 14.

Although not illustrated, the defibrating unit 13 includes a motor that rotationally drives the rotor. The motor is electrically coupled to a control device 28 illustrated in FIG. 3. The rotation speed of the rotor can be adjusted by the control device 28 controlling the energization conditions of the motor via a motor driver (not illustrated). As a result, the defibrating ability of the defibrating unit 13 can be adjusted. Therefore, the surface roughness, the average fiber length, and the like of the cellulose fibers of the defibrated material M3 can be adjusted.

Through the defibrating step, the surface of the cellulose fibers becomes rough, and the cellulose fibers having pores as described later can be obtained. Therefore, in the carbonization step, a carbonized cellulose fibers having pores as described later can be obtained. The defibrating conditions in the defibrating step will be described later.

The conduit 242 is coupled downstream of the defibrating unit 13. A blower 261, for example, configured as a turbo-type fan, is installed in the middle of the conduit 242. The blower 261 is an air flow generating device that generates an air flow toward the sorting unit 14. As a result, the introduction of the roughly ground pieces M2 into the defibrating unit 13 and the delivery of the defibrated material M3 to the sorting unit 14 are promoted. As will be described later, in the defibrating unit 13, the passage and the defibrating process of the roughly ground pieces M2 as the raw material are smoothly performed due to the structure, but the passage and the defibrating process of the roughly ground pieces M2 in the defibrating unit 13 are promoted by the operation of the blower 261 installed downstream of the defibrating unit 13. The blower 261 may be installed upstream of the defibrating unit 13.

The sorting unit 14 is a part that performs the sorting step of sorting the defibrated material M3 according to the fiber length. In the sorting unit 14, the defibrated material M3 is sorted into the first sorted material M4-1 and the second sorted material M4-2 having a larger fiber length than the first sorted material M4-1. The first sorted material M4-1 has a size suitable for the subsequent manufacturing of the carbon fiber structure S. Alternatively, the second sorted material M4-2 includes, for example, those in which defibration is insufficient, and those in which defibrated fibers are excessively aggregated with each other.

The sorting unit 14 includes a drum unit 141 and a housing unit 142 that houses the drum unit 141.

The drum unit 141 is a sieve that is configured with a net body having a circular cylinder shape and rotates around a center axis thereof. The defibrated material M3 flows into the drum unit 141. As the drum unit 141 rotates, the defibrated material M3 that is smaller than the mesh opening is sorted as the first sorted material M4-1, and the defibrated material M3 that is larger than the mesh opening is sorted as the second sorted material M4-2.

The first sorted material M4-1 falls from the drum unit 141.

Meanwhile, the second sorted material M4-2 is delivered to a conduit 243 coupled to the drum unit 141. An end portion of the conduit 243 on a side opposite to the drum unit 141, that is, downstream, is coupled to the middle of the conduit 241. The second sorted material M4-2 passing through the conduit 243 merges with the roughly ground pieces M2 in the conduit 241 and flows into the defibrating unit 13 together with the roughly ground pieces M2. As a result, the second sorted material M4-2 is returned to the defibrating unit 13 and subjected to the defibrating process together with the roughly ground pieces M2.

In addition, the first sorted material M4-1, fallen from the drum unit 141, falls while being dispersed in the air and heads toward the web forming unit 15 located below the drum unit 141. The web forming unit 15 is a part that performs the web forming step of forming the first web M5 from the first sorted material M4-1. The web forming unit 15 includes a mesh belt 151, three stretching rollers 152, and a suction unit 153.

The mesh belt 151 is an endless belt on which the first sorted material M4-1 is deposited. This mesh belt 151 loops around the three stretching rollers 152. By the rotational drive of the stretching rollers 152, the first sorted material M4-1 on the mesh belt 151 is transported downstream.

The first sorted material M4-1 has a size equal to or larger than the opening of the mesh belt 151. As a result, the first sorted material M4-1 is restricted from passing through the mesh belt 151, and can therefore deposit on the mesh belt 151. In addition, the first sorted material M4-1 is transported along with the mesh belt 151 downstream while being deposited on the mesh belt 151, and, thus, is formed into the layer-shaped first web M5.

In addition, for example, dust or dirt may be mixed in the first sorted material M4-1. Dust and dirt may be generated by, for example, crushing or defibration. Such dust and dirt are collected by the collection unit 27 described later.

The suction unit 153 has a suction mechanism that draws air from below the mesh belt 151. As a result, dust and dirt that passes through the mesh belt 151 can be suctioned with the air.

The suction unit 153 is coupled to the collection unit 27 via a conduit 244. The dust and dirt sucked by the suction unit 153 are collected by the collection unit 27.

A conduit 245 is further coupled to the collection unit 27. In addition, a blower 262 is installed in the middle of the conduit 245. The operation of the blower 262 can generate a suction force in the suction unit 153. This promotes the formation of the first web M5 on the mesh belt 151. The first web M5 is obtained with dust, dirt, and the like removed. The dust and dirt reach the collection unit 27 after passing through the conduit 244 by the operation of the blower 262.

The housing unit 142 is coupled to a humidifying unit 232. As a result, humidified air is supplied into the housing unit 142. The first sorted material M4-1 can be humidified by the humidified air, and thus it is possible to suppress the first sorted material M4-1 from adhering to an inner wall of the housing unit 142 due to electrostatic force.

A humidifying unit 235 is disposed downstream of the sorting unit 14. As a result, moisture can be supplied to the first web M5, and the moisture content of the first web M5 is thereby adjusted. By this adjustment, adsorption of the first web M5 onto the mesh belt 151 due to electrostatic force can be suppressed. Accordingly, the first web M5 is easily peeled off from the mesh belt 151 at a position where the mesh belt 151 is folded back by the stretching roller 152.

The subdividing unit 16 is disposed downstream of the humidifying unit 235. The subdividing unit 16 is a part that performs the dividing step of dividing the first web M5 peeled off from the mesh belt 151. The subdividing unit 16 includes a rotatably supported propeller 161 and a housing unit 162 that houses the propeller 161. The first web M5 can be divided by the rotating propeller 161. The divided first web M5 is formed into the subdivided body M6. The subdivided body M6 descends in the housing unit 162.

The housing unit 162 is coupled to a humidifying unit 233. As a result, humidified air is supplied into the housing unit 162. It is possible to suppress the subdivided body M6 from adhering to the propeller 161 and an inner wall of the housing unit 162 due to electrostatic force by the humidified air.

The upstream end of a conduit 172 is coupled downstream of the subdividing unit 16. The conduit 172 couples the housing unit 162 of the subdividing unit 16 and a housing 182 of the dispersing unit 18, and serves as a flow path through which the subdivided body M6 passes.

In addition, a blower 173 is installed in the middle of the conduit 172. The operation of a rotation unit such as a vane provided in the blower 173 makes it possible to generate an air flow toward the dispersing unit 18. With this air flow, the subdivided body M6 can be agitated in the conduit 172. Therefore, the subdivided body M6 are loosened in the process of passing through the conduit 172 and become finer fibers.

As illustrated in FIG. 3, the blower 173 is electrically coupled to the control device 28, and its activation is controlled. The amount of air supplied into a drum 181 can be adjusted by controlling the airflow of the blower 173.

Although not illustrated, an end portion of the conduit 172 on the drum 181 side is bifurcated, and the bifurcated end portions are respectively coupled to introduction ports (not illustrated) formed in the end surface of the drum 181.

The dispersing unit 18 illustrated in FIG. 1 is a part that performs the dispersing step of loosening and dispersing the fibers entangled with each other in the subdivided body M6. The dispersing unit 18 includes the drum 181 that introduces and discharges the subdivided body M6 which is the defibrated material, and the housing 182 that houses the drum 181.

The drum unit 181 is a sieve that is configured with a net body having a circular cylinder shape and rotates around a center axis thereof. As the drum 181 rotates, fibers or the like of the subdivided body M6 smaller than the mesh opening can pass through the drum 181. At this time, the subdivided body M6 are loosened and discharged together with the air. That is, the drum 181 functions as a discharge unit that discharges the material containing fibers.

The drum 181 is coupled to a drive source (not illustrated) and is rotated by a rotational force output from the drive source. The drive source is electrically coupled to the control device 28, and the operation thereof is controlled.

The housing 182 is coupled to a humidifying unit 234. As a result, humidified air is supplied into the housing 182. The interior of the housing 182 can be humidified by the humidified air, and thus it is possible to suppress the subdivided body M6 from adhering to an inner wall of the housing 182 due to electrostatic force.

In addition, the subdivided body M6 discharged by the drum 181 falls while being dispersed in the air and heads toward the depositing unit 19 located below the drum 181. The depositing unit 19 is a part that performs the depositing step of depositing the subdivided body M6 to form the second web M7 which is a deposit. The depositing unit 19 includes a mesh belt 191, four stretching rollers 192, and a suction unit 193.

The mesh belt 191 is a mesh member, and is an endless belt in the illustrated configuration. In addition, the subdivided body M6 dispersed and discharged by the dispersing unit 18 is deposited on the mesh belt 191. The mesh belt 191 loops around the four stretching rollers 192. By the rotational drive of the stretching rollers 192, the subdivided body M6 on the mesh belt 191 is transported downstream.

In the illustrated configuration, the mesh belt 191 is used as an example of the mesh member, but the mesh member may have a flat plate shape, for example.

In addition, almost all of the subdivided body M6 on the mesh belt 191 have a size equal to or larger than the mesh opening of the mesh belt 191. As a result, the subdivided body M6 is restricted from passing through the mesh belt 191, and can therefore deposit on the mesh belt 191. In addition, the subdivided body M6 is transported along with the mesh belt 191 downstream while being deposited on the mesh belt 191, and, thus, is formed into the layer-shaped second web M7.

The suction unit 193 has a suction mechanism that draws air from below the mesh belt 191. Accordingly, the subdivided body M6 can be sucked onto the mesh belt 191, and thus the deposition of the subdivided body M6 on the mesh belt 191 is promoted.

A conduit 246 is coupled to the suction unit 193. In addition, a blower 263 is installed in the middle of the conduit 246. The operation of the blower 263 can generate a suction force in the suction unit 193.

A humidifying unit 236 is disposed downstream of the dispersing unit 18. As a result, moisture can be supplied to the second web M7, and the moisture content of the second web M7 is thereby adjusted. By this adjustment, adsorption of the second web M7 onto the mesh belt 191 due to electrostatic force can be suppressed. Accordingly, the second web M7 is easily peeled off from the mesh belt 191 at a position where the mesh belt 191 is folded back by the stretching roller 192.

For example, a total moisture amount from the humidifying unit 231 to the humidifying unit 236 is preferably 0.5 parts by mass or larger and 20 parts by mass or smaller in terms of 100 parts by mass of a material before humidifying.

As illustrated in FIGS. 1 and 2, the density adjustment unit 23 that adjusts the density of the second web M7 is disposed downstream of the depositing unit 19. The density adjustment unit 23 is a part that performs the density adjusting step. The density adjustment unit 23 includes a pair of calender rollers 230 and 230 and a roller shaft distance adjustment mechanism 238. In the density adjustment unit 23, the second web M7 can be pressurized in its thickness direction by passing the second web M7 between the pair of calender rollers 230 and 230, thereby increasing the density of the second web M7.

In the density adjustment unit 23, the roller shaft distance (separation distance) between the pair of calender rollers 230 and 230 can be adjusted by the operation of the roller shaft distance adjustment mechanism 238. As a result, a pressing force applied to the passing second web M7 is adjusted, thereby the density of the second web M7 can be set to a desired value.

As illustrated in FIG. 3, the roller shaft distance adjustment mechanism 238 is electrically coupled to the control device 28, and the control device 28 controls the energization conditions of the roller shaft distance adjustment mechanism 238, thereby adjusting the roller shaft distance between the pair of calender rollers 230 and 230, that is, the pressing force applied to the second web M7.

The second web M7, which has been pressurized by passing between the pair of calender rollers 230 and 230 and adjusted to a desired density, is transported toward the carbonization unit 3, which performs the next step. One of the pair of calender rollers 230 and 230 is a main roller driven by the operation of a motor (not illustrated), and the other is a driven roller. The pair of calender rollers 230 and 230 have both a function of transporting the second web M7 downstream and a function of adjusting its density by pressurization. The motor that drives the calender roller 230 is electrically coupled to the control device 28, and the rotation speed, the rotation timing, and the like are controlled.

As described above, by appropriately setting the roller shaft distance of the pair of calender rollers 230 and 230, it is possible to adjust the thickness of the second web M7 fed to the carbonization unit 3 and to appropriately adjust the density level of the resulting carbon fiber structure S. The magnitude relationships of the roller shaft distance of the pair of calender rollers 230 and 230, the thickness of the second web M7 fed to the carbonization unit 3, and the density of the carbon fiber structure S after passing through the carbonization unit 3 correspond to each other.

The carbonization unit 3 is disposed downstream of the density adjustment unit 23.

The carbonization unit 3 illustrated in FIG. 2 is a part that performs the carbonization step. That is, the carbonization unit 3 performs a heat treatment on the second web M7 to carbonize the cellulose fibers and produce the carbon fiber structure S made of the carbonized cellulose fibers.

"Carbonization" includes the conversion of cellulose fibers into carbon through dehydration and graphitization. Further, "the cellulose fibers are carbonized" means that 75% by weight or more, preferably 90% by weight or more, of the cellulose fibers contained in the second web M7 have been carbonized.

The carbonization unit 3 includes a chamber 31, a heater 32 and a heater 33 provided in the chamber 31, an inert gas supply unit 34, and a decompression unit 35.

The chamber 31 has an internal space S0, a supply port 311 from which the second web M7 is supplied, and a discharge port 312 for discharging the carbon fiber structure S. The supply port 311 is provided at an upstream wall of the chamber 31, and the discharge port 312 is provided at a downstream wall of the chamber 31.

Although not illustrated, the supply port 311 and the discharge port 312 are preferably provided with a seal member or a labyrinth structure for ensuring or improving airtightness.

The band-shaped second web M7 supplied from the supply port 311 into the internal space S0 of the chamber 31 is subjected to the heat treatment in the internal space S0, and the cellulose fibers contained in the second web M7 are carbonized to form carbon fibers. Thus, the carbon fiber structure S is produced. The produced carbon fiber structure S is discharged from the discharge port 312 in its band shape.

In the carbonization unit 3, the heat treatment is continuously performed on the second web M7 without stopping the transport of the second web M7. Accordingly, carbonization by the heat treatment can be performed rapidly and uniformly, and the productivity of the carbon fiber structure S can be increased.

The heater 32 is disposed above the second web M7 or the carbon fiber structure S in the internal space S0, and the heater 33 is disposed below the second web M7 or the carbon fiber structure S in the internal space S0. As a result, the second web M7 can be heated from both sides, and the heat treatment can be rapidly and uniformly performed on the second web M7.

As illustrated in FIG. 3, the heater 32 and the heater 33 are electrically coupled to the control device 28, and the control device 28 controls the energization conditions of the heater 32 and the heater 33. Accordingly, the heater 32 and the heater 33 generate heat at desired timings and at desired amounts, and can perform the heat treatment on the second web M7.

The heating temperature of the second web M7 by the operation of the heater 32 and the heater 33 is not particularly limited as long as the second web M7 can be carbonized when the second web M7 passes through the internal space S0, but is preferably 200°C or higher and 1500°C or less, and more preferably 300°C or higher and 800°C or less. Accordingly, the cellulose fibers contained in the second web M7 can be carbonized rapidly and uniformly.

In particular, when the heating temperature of the second web M7 by the operation of the heater 32 and the heater 33 is 300°C or higher, the cellulose fibers contained in the second web M7 can be carbonized more rapidly and more uniformly.

When the heating temperature of the second web M7 by the operation of the heater 32 and the heater 33 is 300°C or higher and 800°C or less, the heating time of the second web M7 is preferably 10 seconds or more and 300 seconds or less, and more preferably 30 seconds or more and 100 seconds or less. Accordingly, the cellulose fibers contained in the second web M7 can be carbonized more rapidly and more uniformly.

When the heating temperature of the second web M7 by the operation of the heater 32 and the heater 33 is 800°C or higher and less than 1500°C, the heating time of the second web M7 is preferably 10 seconds or more and 50 seconds or less, and more preferably 20 seconds or more and 80 seconds or less. Accordingly, the cellulose fibers contained in the second web M7 can be carbonized more rapidly and more uniformly.

The heating time of the second web M7 is the time during which the second web M7 remains in the internal space S0 of the chamber 31. In other words, focusing on an any portion of the second web M7, the time during which the any portion remains in the internal space S0 of the chamber 31 is defined as the heating time.

By the control of the control device 28, it is possible to adjust the rotation speed and the rotation timing of each of the stretching rollers 192, the calender rollers 230 and 230, and the calender rollers 201 and 201, thus enabling the transport speed and the transport timing of the second web M7 and the carbon fiber structure S to be set to desired transport speed and a desired transport timing. In addition, the control device 28 can control the heat generation (heating temperature) of the heaters 32 and 33, and can control the transport speed of the second web M7 as it passes through the internal space S0, thereby adjusting the heating time of the second web M7 and achieving appropriate carbonization of the second web M7.

As illustrated in FIG. 2, the inert gas supply unit 34 supplies an inert gas G such as nitrogen gas to the internal space S0 of the chamber 31. Accordingly, the heat treatment can be performed under an inert gas atmosphere, that is, under a non-oxidizing atmosphere. As a result, the cellulose fibers contained in the second web M7 can be carbonized more uniformly.

The inert gas supply unit 34 includes an inert gas storage unit 341, a supply conduit 342 that couples the inert gas storage unit 341 and the chamber 31, and an electromagnetic valve 343 that opens and closes the supply conduit 342. As illustrated in FIG. 3, the electromagnetic valve 343 is electrically coupled to the control device 28, and the opening degree and the opening/closing timing of the electromagnetic valve 343 are adjusted by the control of the control device 28. By adjusting the opening degree and the opening/closing timing of the electromagnetic valve 343, the supply amount of the inert gas G into the chamber 31 can be adjusted.

Examples of the inert gas G include, but are not particularly limited to, nitrogen gas, argon gas, helium gas, and neon gas, and these gases can be used alone or in combination as appropriate.

The decompression unit 35 decompresses the internal space S0 of the chamber 31. By performing the heat treatment under a reduced pressure atmosphere, the cellulose fibers contained in the second web M7 can be carbonized more uniformly.

The decompression unit 35 includes a suction pump 351 and a suction conduit 352 that couples the suction pump 351 and the chamber 31. As illustrated in FIG. 3, the suction pump 351 is electrically coupled to the control device 28, and controls the energization conditions of the suction pump 351 by the operation of the control device 28. Accordingly, the suction pump 351 performs suction at a desired timing and with a desired suction force, thereby the internal space S0 of the chamber 31 can be decompressed.

The pressure in the internal space S0 of the chamber 31 is preferably 500 kPa or less, and more preferably 300 kPa or less. Accordingly, the cellulose fibers contained in the second web M7 can be carbonized more uniformly.

The heat treatment in the carbonization unit 3 is preferably performed under a non-oxidizing atmosphere at a pressure of 500kPa or less. Accordingly, the cellulose fibers contained in the second web M7 can be carbonized more uniformly.

In particular, the carbonization step is preferably performed under a non-oxidizing atmosphere at a pressure of 500 kPa or less and at a heating temperature of 200°C or higher and 1500°C or less, and is more preferably performed under a non-oxidizing atmosphere at a pressure of 300 kPa or less and at a heating temperature of 300°C or higher and 800°C or less. Accordingly, the cellulose fibers contained in the second web M7 can be carbonized more uniformly.

Examples of the non-oxidizing atmosphere include an inert gas atmosphere, such as nitrogen gas, argon gas, helium gas, and neon gas; a reducing gas atmosphere; hydrogen gas; reduced-pressure air; and vacuum.

As described above, in the carbon fiber structure manufacturing apparatus 100, the carbon fiber structure S can be easily manufactured by sequentially performing the defibrating step, the depositing step, and the carbonization step. In particular, for example, the physical properties such as the average fiber length of the cellulose fibers and the surface roughness of the cellulose fibers can be appropriately set by appropriately setting the degree of defibration in the defibrating step. Therefore, the characteristics of the carbonized cellulose fibers can be appropriately set by carbonizing the cellulose fibers.

As illustrated in FIG. 1, the forming unit 20 is disposed downstream of the carbonization unit 3. The forming unit 20 is a part that performs the forming step of forming the carbon fiber structure S into a desired shape, which, in the present embodiment, is a sheet shape. The forming unit 20 includes a pair of calender rollers 201 and 201, and the carbon fiber structure S can be pressurized in its thickness direction by passing the carbon fiber structure S between the pair of calender rollers 201 and 201. Thereby, the density of the carbon fiber structure S is increased. Although not illustrated, the forming unit 20 may have a roller shaft distance adjustment mechanism similar to the roller shaft distance adjustment mechanism 238, and may be configured to adjust the density of the carbon fiber structure S by adjusting the roller shaft distance (separation distance) between the pair of calender rollers 201 and 201.

The carbon fiber structure S, which has been pressurized by passing between the pair of calender rollers 201 and 201, and the density of which has been adjusted, is transported toward the cutting unit 21, which performs the next step. One of the pair of calender rollers 201 and 201 is a main roller driven by the operation of a motor (not illustrated), and the other is a driven roller. The pair of calender rollers 201 and 201 have both a function of transporting the carbon fiber structure S downstream and a function of adjusting its density by pressurization. The motor that drives the calender roller 201 is electrically coupled to the control device 28 illustrated in FIG. 3, and the rotation speed, the rotation timing, and the like are controlled.

As described above, in a configuration in which the roller shaft distance of the pair of calender rollers 201 and 201 can be appropriately set, the thickness of the carbon fiber structure S that is to be fed to the next step can be adjusted, and the density of the carbon fiber structure S can be appropriately adjusted. The magnitude relationships of the roller shaft distance of the pair of calender rollers 201 and 201, the thickness of the carbon fiber structures S fed to the cutting unit 21, and the density of the carbon fiber structure S correspond to each other.

The cutting unit 21 is disposed downstream of the forming unit 20. The cutting unit 21 is a part that performs the cutting step of cutting the carbon fiber structure S into a desired planar shape and size. The cutting unit 21 includes a first cutter 211 and a second cutter 212. Each of the first cutter 211 and the second cutter 212 is operated by a drive source such as a motor or a solenoid (not illustrated).

The first cutter 211 is configured to cut the carbon fiber structure S in a direction intersecting, particularly perpendicular to, the transport direction of the carbon fiber structure S.

The second cutter 212 is configured to cut the carbon fiber structure S in a direction parallel to the transport direction of the carbon fiber structure S downstream of the first cutter 211. This cutting is to adjust the width of the carbon fiber structure S by removing unnecessary portions at both ends in a width direction of the carbon fiber structure S.

As illustrated in FIG. 3, each of the first cutter 211 and the second cutter 212 is electrically coupled to the control device 28, and the timing of cutting and the like is controlled by the operation of the control device 28.

By such cutting with the first cutter 211 and the second cutter 212, the carbon fiber structure S having the desired planar shape and size can be obtained. Examples of the desired planar shape of the carbon fiber structure S include a square, a rectangle, and a band shape. Other shapes such as a circle and an ellipse may be used.

The carbon fiber structure S having the desired shape and size as described above is further transported downstream and deposited in the stock unit 22.

As described above, each unit provided in the carbon fiber structure manufacturing apparatus 100 is electrically coupled to the control device 28. The operations of each of these units are controlled by the control device 28.

As illustrated in FIG. 3, the control device 28 includes a control unit 281, a storage unit 282, and a communication unit 283.

The control unit 281 includes at least one processor and executes various programs stored in the storage unit 282. As the processor, for example, a central processing unit (CPU) can be used. The control unit 281 has various functions, such as a function of controlling the driving of the heaters 32 and 33, the electromagnetic valve 343, and the suction pump 351 in the carbon fiber structure manufacturing apparatus 100.

The storage unit 282 stores, for example, various programs, such as a program related to the manufacturing of the carbon fiber structure S, a program related to the operation sequence of the defibrating unit 13, a program related to the operation sequence of the density adjustment unit 23, a program related to the operation sequences of the heater 32 and the heater 33, a program related to the operation sequence of the inert gas supply unit 34, a program related to the operation sequence of the decompression unit 35, a program related to the operation sequence of the forming unit 20, and a program related to the operation sequence of the cutting unit 21.

The communication unit 283 is, for example, configured with an I/O interface and communicates with each unit of the carbon fiber structure manufacturing apparatus 100. The communication unit 283 has a function of communicating with a computer or a server (not illustrated) via a network, for example.

The control device 28 may be built in the carbon fiber structure manufacturing apparatus 100 or may be provided in an external device such as an external computer. In addition, for example, the control unit 281 and the storage unit 282 may be integrated and configured as one unit, the control unit 281 may be built in the carbon fiber structure manufacturing apparatus 100 and the storage unit 282 may be provided in an external device such as an external computer, or the storage unit 282 may be built in the carbon fiber structure manufacturing apparatus 100 and the control unit 281 may be provided in an external device such as an external computer.

By the control device 28 controlling the operation of each unit of the carbon fiber structure manufacturing apparatus 100, each step as described above is performed, and the carbon fiber structure S can be manufactured.

The carbonization step may be configured to be performed intermittently and discontinuously on the second web M7, for example, in a batch-processing manner.

Further, the density adjusting step may be omitted. That is, the density adjustment unit 23 may be omitted.

The forming step may be omitted. That is, the forming unit 20 may be omitted.

The cutting step may be omitted. That is, the cutting unit 21 may be omitted. In this case, it is preferable that the stock unit 22 is configured to wind the band-shaped carbon fiber structure S into a roll shape.

### Carbon Fiber Structure (Filter)

Next, the obtained carbon fiber structure S will be described in detail. Hereinafter, a case where the carbon fiber structure S is processed into a predetermined size and shape and used as a filter will be described. Hereinafter, the carbon fiber structure S is referred to as a "filter 1".

As described above, the filter 1 includes the carbonized cellulose fibers obtained by carbonizing the cellulose fibers. The carbonized cellulose fibers have a large number of pores open to the surface. The pores are opened in the surface of the cellulose fibers, and the opening diameters (pore diameters) thereof may be different from each other. The present inventors have focused on the distribution of the pore diameter for each size, and have found that the filter 1 selectively adsorbs a specific substance when the number of pores with pore diameters of 1 nm or more and 50 nm or less is larger than that of pores with pore diameters of less than 1 nm, thereby completing the present disclosure. Hereinafter, this will be described below.

Note that caffeine contained in the beverage will be described as the specific substance selectively adsorbed by the filter 1.

FIG. 4 is a graph illustrating the frequency distribution of the pore diameters of the carbonized cellulose fibers, comparing the activated carbon of the related art (for example, a fibrous activated carbon manufactured by AS ONE Corporation) with the filter 1 of the present disclosure.

The frequency distribution is obtained by a small angle X-ray scattering method. That is, the above-mentioned frequency distribution can be obtained by irradiating an object (activated carbon of the related art and the carbonized cellulose fibers of Filter 1) with X-rays, measuring the small-angle scattering of the X-rays, and from the measured scattering vectors and scattering intensities, estimating respectively, the number of pores having a pore diameter of 1nm, the number of pores having a pore diameter of 5 nm, the number of pores having a pore diameter of 50 nm, and the number of pores having a pore diameter of 500 nm. The graph illustrated in FIG. 4 represents the data of the frequency distribution by a bar graph.

For the above-mentioned measurement, a high-intensity radiation facility, for example, SPring-8 can be used.

In the activated carbon of the related art, pores having a pore diameter of 0.8 nm or more and 1.2 nm or less account for about 78% of the total, pores having a pore diameter of 4.0 nm or more and 6.0 nm or less account for about 8% of the total, pores having a pore diameter of 40 nm or more and 60 nm or less account for about 2% of the total, and pores having a pore diameter of 60 nm or more and 500 nm or less account for about 12% of the total. With such a frequency distribution, caffeine having an average particle size of about 1.0 nm or more and 30 nm or less cannot be selectively adsorbed.

In contrast, for the filter 1, pores having a pore diameter of 0.8 nm or more and 1.2 nm or less account for about 4% of the total, pores having a pore diameter of 4.0 nm or more and 6.0 nm or less account for about 15% of the total, pores having a pore diameter of 40 nm or more and 60 nm or less account for about 25% of the total, and pores having a pore diameter of 60 nm or more and 500 nm or less account for about 56% of the total. With such a frequency distribution, caffeine can be selectively adsorbed.

As described above, in the carbonized cellulose fibers of the filter 1, the number of pores having a pore diameter of 4.0 nm or more and 60 nm or less is larger than the number of pores having a pore diameter of 0.8 nm or more and 1.2 nm or less. Accordingly, the filter 1 can selectively adsorb, for example, caffeine (specific substance), and the filter 1 can be used as, for example, a coffee filter (beverage filter). Therefore, by passing coffee through the filter 1, coffee from which caffeine has been removed can be obtained.

When the number of pores having a pore diameter of 4.0 nm or more and 60 nm or less is smaller than the number of pores having a pore diameter of 0.8 nm or more and 1.2 nm or less, as in the activated carbon of the related art, the adsorption of caffeine is insufficient, and substances other than caffeine, such as polyphenols, tend to be adsorbed. That is, when the number of pores having a pore diameter of 4.0 nm or more and 60 nm or less is smaller than the number of pores having a pore diameter of 0.8 nm or more and 1.2 nm or less, caffeine cannot be selectively adsorbed.

In the filter 1, the pores having a pore diameter of 0.8 nm or more and 1.2 nm or less account for preferably 2% or more and 19% or less of the total, and more preferably 3% or more and 6% or less of the total. Accordingly, it is possible to more effectively prevent the filter 1 from adsorbing substances other than caffeine, such as polyphenols.

In addition, in the filter 1, the pores having a pore diameter of 4.0 nm or more and 6.0 nm or less account for preferably 5% or more and 25% or less of the total, and more preferably 10% or more and 20% or less of the total. Accordingly, the filter 1 can more effectively adsorb, for example, caffeine.

In the filter 1, the pores having a pore diameter of 40 nm or more and 60 nm or less account for preferably 5% or more and 25% or less of the total, and more preferably 10% or more and 20% or less of the total. Accordingly, the filter 1 can more effectively adsorb, for example, caffeine.

In the filter 1, the pores having a pore diameter of 60 nm or more and 500 nm or less account for preferably 40% or more and 65% or less of the total, and more preferably 50% or more and 60% or less of the total. Accordingly, the filter 1 can more effectively adsorb, for example, caffeine.

In addition, in the frequency distribution of the pore diameters, when A represents the frequency of pores having a pore diameter of 4.0 nm or more and 60 nm or less, and B represents the frequency of pores having a pore diameter of 0.8 nm or more and 1.2 nm or less, the ratio A/B is preferably 1.5 or more and 100 or less, and more preferably 3.0 or more and 10 or less. Accordingly, the filter 1 can more favorably adsorb, for example, caffeine (specific substance).

In addition, the frequency distribution of the pore diameters preferably has a local maximum value in a region of 3.0 nm or more and 5.0 nm or less, and more preferably has a local maximum value in a region of 3.5 nm or more and 4.5 nm or less. Accordingly, the filter 1 can more favorably adsorb, for example, caffeine (specific substance).

In the frequency distribution of pore diameters in the region of 500 nm or less, the frequency in the region of 0.8 nm or more and 1.2 nm or less is preferably 1.0% or more and 5.0% or less, and more preferably 1.5% or more and 3.5% or less. Accordingly, it is possible to prevent the filter 1 from adsorbing substances other than caffeine, such as trigonelline and quinic acid. Therefore, the filter 1 can more favorably and selectively adsorb, for example, caffeine (specific substance).

The average fiber length of the carbonized cellulose fibers is not particularly limited, but is preferably 0.1 mm or more and 5 mm or less, and more preferably 0.2 mm or more and 3 mm or less. Accordingly, the filter 1 can more favorably and more reliably adsorb, for example, caffeine (specific substance). The average fiber length of the carbonized cellulose fibers can be measured by, for example, a staple diagram method.

From the same viewpoint, the average diameter (average width) of the carbonized cellulose fibers is not particularly limited, but is preferably 0.5 μm or more and 200 μm or less, and more preferably 1.0 μm or more and 100 μm or less.

From the same viewpoint, the average aspect ratio (ratio of the average length to the average width) of the carbonized cellulose fibers is not particularly limited, but is preferably 10 or more and 1000 or less, and more preferably 15 or more and 500 or less from the same viewpoint as the above-mentioned fiber length.

The content of the carbonized cellulose fibers in the filter 1 is not particularly limited, but is preferably 50% by weight or more and 97% by weight or less, and more preferably 60% by weight or more and 85% by weight or less. Accordingly, it is possible to more remarkably exhibit the above-mentioned effect by containing the carbonized cellulose fiber.

The density of the carbonized cellulose fibers in the filter 1 is not particularly limited, but is preferably 0.01 mg/cm³ or more and 1.0 mg/cm³ or less, and more preferably 0.1 mg/cm³ or more and 0.5 mg/cm³ or less. Accordingly, it is possible to more remarkably exhibit the above-mentioned effect by containing the carbonized cellulose fiber.

The thickness of the filter 1 is not particularly limited, and is, for example, preferably 0.1 mm or more and 10 mm or less, and more preferably 0.2 mm or more and 2 mm or less. Accordingly, the filter 1 can more favorably and more reliably adsorb, for example, caffeine (specific substance).

The carbonized cellulose fibers having such pores can be manufactured, for example, by adjusting the rotation speed of the rotor when the defibrating unit 13 performs the defibrating process, and the time during which the defibrating unit 13 performs the defibrating process.

The rotation speed of the rotor during the defibrating process performed by the defibrating unit 13 is, for example, preferably 1000 rpm or more and 10000 rpm or less, and more preferably 3000 rpm or more and 5000 rpm or less. Accordingly, the defibration process can be favorably performed, and the carbonized cellulose fibers having the frequency distribution of pores as described above can be more effectively obtained.

The time during which the defibrating unit 13 performs the defibrating process is not particularly limited, but is preferably 5 seconds or more and 180 seconds or less, and more preferably 10 seconds or more and 60 seconds or less. Accordingly, the defibration process can be favorably performed, and the carbonized cellulose fibers having the frequency distribution of pores as described above can be more effectively obtained.

The filter 1 may contain components other than the carbonized cellulose fibers. Examples of the components other than the carbonized cellulose fibers include calcium carbonate.

When the filter 1 contains the components other than the carbonized cellulose fibers, the content of the components other than the carbonized cellulose fibers in the filter 1 is not particularly limited, but is preferably 3% by weight or more and 50% by weight or less, and more preferably 15% by weight or more and 40% by weight or less. Accordingly, it is possible to more remarkably exhibit the effects by the filter 1 containing the components other than the carbonized cellulose fibers.

As described above, the filter 1 is a filter that contains carbonized cellulose fibers obtained by carbonizing cellulose fibers and captures a specific substance (for example, caffeine), wherein the carbonized cellulose fibers have a large number of pores opening to the surface, and the number of pores having a pore diameter of 4.0 nm or more and 60 nm or less is larger than the number of pores having a pore diameter of 0.8 nm or more and 1.2 nm or less. Accordingly, the filter 1 can selectively adsorb, for example, caffeine (specific substance), and the filter 1 can be used as, for example, a coffee filter. Therefore, by passing coffee through the filter 1, coffee from which caffeine has been removed can be obtained.

The filter 1 is preferably used as a beverage filter for capturing caffeine. Thus, by passing a beverage (for example, coffee) through the filter 1, the beverage from which caffeine has been removed can be obtained.

In the frequency distribution of the pore diameters, when A represents the frequency of pores having a pore diameter of 4.0 nm or more and 60 nm or less, and B represents the frequency of pores having a pore diameter of 0.8 nm or more and 1.2 nm or less, the ratio A/B is preferably 1.5 or more and 100or less, and more preferably 3.0 or more and 10 or less. Accordingly, the filter 1 can more favorably adsorb, for example, caffeine (specific substance).

In addition, the frequency distribution of the pore diameters preferably has a local maximum value in a region of 3.0 nm or more and 5.0 nm or less. Accordingly, the filter 1 can more favorably adsorb, for example, caffeine (specific substance).

In the frequency distribution of pore diameters in a region of 500 nm or less, the frequency in a region of 0.8 nm or more and 1.2 nm or less is 1% or more and 5% or less. Accordingly, it is possible to prevent adsorption of substances other than caffeine, such as trigonelline and quinic acid. Therefore, the filter 1 can more favorably and selectively adsorb, for example, caffeine (specific substance).

The density of the carbonized cellulose fibers in the filter 1 is preferably 0.01 mg/cm³ or more and 1.0 mg/cm³ or less. Accordingly, the filter 1 can more favorably adsorb, for example, caffeine (specific substance).

The average fiber length of the carbonized cellulose fibers is not particularly limited, but is preferably 0.1 mm or more and 5.0 mm or less, and more preferably 0.2 mm or more and 3.0 mm or less. Accordingly, the filter 1 can more favorably and more reliably adsorb, for example, caffeine (specific substance).

As described above, while the present disclosure has been described with reference to the preferred embodiment of the present disclosure, the present disclosure is not limited thereto.

What is claimed is:

1. A filter, comprising carbonized cellulose fibers obtained by carbonizing cellulose fibers, and configured to capture a specific substance,
wherein the carbonized cellulose fibers have a large number of pores opening to a surface, and
a number of the pores having a pore diameter of 4.0 nm or more and 60 nm or less is larger than a number of the pores having a pore diameter of 0.8 nm or more and 1.2 nm or less.

2. The filter according to claim 1, wherein in a frequency distribution of the pore diameters, when A represents a frequency of the pores having a pore diameter of 4.0 nm or more and 60 nm or less, and B represents a frequency of the pores having a pore diameter of 0.8 nm or more and 1.2 nm or less, a ratio A/B is 1.5 or more and 100 or less.

3. The filter according to claim 1, wherein the frequency distribution of the pore diameters has a local maximum value in a region of 3.0 nm or more and 5.0 nm or less.

4. The filter according to claim 1, wherein in a frequency distribution of the pore diameters in a region of 500 nm or less, a frequency in a region of 0.8 nm or more and 1.2 nm or less is 1% or more and 5% or less.

5. The filter according to claim 1, wherein a density of the carbonized cellulose fibers is 0.01 mg/cm³ or more and 1.0 mg/cm³ or less.

6. The filter according to claim 1, wherein an average fiber length of the carbonized cellulose fibers is 0.1 mm or more and 5.0 mm or less.

7. The filter according to claim 1, which is used as a beverage filter for capturing caffeine.
